(19) United States
(12) Patent Application Publication
(10) Pub. No.: US 2024/0341236 A1
(43) Pub. Date: Oct. 17, 2024

(54) PROCESSING MACHINE FOR FIBER PLANTS

(71) Applicant: HYLER BV, Sint-Baafs-Vijve (BE)

(72) Inventor: Niels BAERT, Sint-Baafs-Vijve (BE)

(21) Appl. No.: 18/579,790

(22) PCT Filed: Jul. 18, 2022
(86) PCT No.: PCT/IB2022/056598

§ 371 Date: Jan. 16, 2024

(30) Foreign Application Priority Data
Jul. 19, 2021 (BE) 2021/5564

(51) Int. Cl. A01D 45/06; A01D 45/30; A01D 61/00

(52) U.S. Cl. CPC A01D 45/065; A01D 45/30; A01D 61/008

(57) ABSTRACT

The invention relates to a processing machine for processing fibre plants, such as hemp or flax. The processing machine can comprise:—a self-propelling vehicle;—a seed part removing unit which is mounted on the self-propelling vehicle and is configured to remove seed parts (such as bolls) from the fibre plants to be picked;—a picking unit which is mounted on the vehicle and is configured to pick fibre plants from which seed parts have been removed, wherein the picking unit is further configured to transport the picked fibre plants to the conveyor of the self-propelling vehicle. The seed part removing unit can for instance be a stripper for stripping the seed parts from the fibre plants.

The present invention relates to a processing machine for processing fibre plants and to a method for processing fibre plants with such a processing machine.

Numerous different machines have been developed over time for harvesting fibre plants, for instance relatively short fibre plants such as flax or relatively long fibre plants such as hemp, and subsequent processing thereof. On one hand there are picking machines with which the relatively short fibre plants can be picked or picking machines with which the relatively long fibre plants can be picked, wherein these picking machines can place the picked fibre plants flat on the ground surface in rows (swathes) in order to be retted. On the other hand so-called turners have been developed with which fibre plants, once they have been placed down flat on the ground at an earlier stage, can be picked up, be turned over and can be placed back onto the ground in turned-over position. Numerous variants of these types of processing machine are in turn known. Considering the great differences in properties between the different fibre plants, including the properties such as length, but also the composition of the plants, a separate processing machine is in principle utilized for each processing step and for each fibre plant.

Useful components of fibre plants in general are fibres, wood-like parts and seed. The seed is located as seed parts such as bolls in the top portion or the Cannabidiol (CBD) portion. Picking machines are known wherein the fibre plants are picked as one whole, are collected and later processed in order to separate the seed from the fibres and wood-like parts. A drawback of these machines is that the fibre plants are then particularly used to extract seed, the other components such as fibres and wood-like parts do not undergo a retting process and are thereby less useful for determined applications. As described above, picking machines are also known wherein the picked fibre plants are placed flat on the ground (in swathes) in order to undergo a retting process on the ground. A drawback of these picking machines is that the seed on the fibre plants placed on the ground is lost.

There is a need for a processing machine and a method for processing fibre plants wherein the stated and/or other drawbacks are reduced. The processing machine is preferably suitable for use in a method wherein picking and deseeding of fibre plants are combined in a less objectionable manner. The processing machine should further be suitable to be able to place the fibre plants onto the ground in at least two swathes adjacently of each other when processing relatively long fibre plants. It is another object to provide a processing machine which is suitable for alternataly performing different combinations of processing operations, particularly picking, placing on the ground and deseeding of fibre plants. It is another object to provide a processing machine which is suitable for processing fibre plants of different lengths, particularly flax and hemp.

In order to achieve at least one of the objects at least partially, a processing machine for processing fibre plants is provided according to a first aspect, the processing machine comprising:
a self-propelling vehicle comprising a vehicle chassis with arranged thereon a number of wheels and a drive motor for driving at least one of the wheels, wherein the vehicle chassis is provided with at least one fibre plant conveyor which is configured to transport at least parts of the fibre plants from a first outer end of the vehicle chassis to an opposite, second outer second end, and with at least one delivering unit provided at or close to the second outer end and configured to deliver and place on the ground surface the fibre plants coming from the at least one conveyor;
a seed part removing unit which is mounted or mountable on the self-propelling vehicle and is configured to remove seed parts, particularly bolls, from the fibre plants to be picked;
a picking unit which is mounted on the self-propelling vehicle and is configured to pick fibre plants from which seed parts have been removed, wherein the picking unit is further configured to transport the picked fibre plants to the conveyor of the self-propelling vehicle.

The seed part removing unit is configured to deseed the fibre plants to be picked. Such a processing machine which is able to deseed and pick the fibre plants and then place them on a ground surface (for retting) provides an improved option for efficiently processing the fibre plants in the desired manner.

In the processing machine the seed part removing unit and/or the picking unit can be mounted directly and/or each individually on the vehicle chassis. In other embodiments the seed part removing unit is mounted on the picking unit and the picking unit on the vehicle chassis. The seed part removing unit is then thus mounted on the vehicle chassis in indirect manner. In yet other embodiments this is the other way around: the seed part removing unit is mounted directly on the vehicle chassis and the picking unit it is mounted on the seed part removing unit.

In an embodiment the processing machine comprises a separating unit, wherein the separating unit is configured to separate the supplied seed parts into a first stream and a second stream, wherein the first stream comprises substantially air, chaff particles and dust particles and the second stream comprises substantially seed parts, wherein the separating unit is preferably releasable and/or the separating unit is arranged on the vehicle chassis.

The separating unit comprises a first discharge for discharging the first stream and a second discharge for discharging the second stream. The two streams can be discharged separately of each other. In determined embodiments the first stream is blown into the surrounding air but the second stream is stored for later use, for instance stored in a seed part container arranged on the vehicle chassis.

In determined embodiments the seed part removing unit comprises a stripper for removing the seed parts, particularly the bolls at the free outer ends of the fibre plants, from the fibre plants to be picked. The seed parts are as it were stripped from the top ends of the fibre plants, wherein the top ends in fact remain intact and can be placed on the ground for retting.

In determined embodiments the seed part removing unit comprises a rotatable removing element which is provided with radial fingers for removing the seed parts from the fibre plants when the removing element rotates, particularly for stripping the seed parts off the fibre plants. Such a construction can ‘scrape’ the seed off the fibre plants (this including cutting off and/or ripping off) very quickly and efficiently, wherein the seed is in principle not damaged and can be easily collected while the stem of the fibre plant still remains available as a whole for further processing steps. Processing steps can for instance comprise picking, turning over, placing on the ground, cutting into pieces (root part, top part and intermediate part) and/or pressing.

According to further embodiments, the processing machine comprises discharge means for collecting and discharging the removed seed parts. In determined embodiments these discharge means extend between the seed part removing unit and the separating unit to be described below. In other embodiments, for instance embodiments without separating unit, the discharge means debouch for instance directly in the collecting unit to be described below, such as a seed part receptacle mounted on the self-propelling vehicle.

The discharge means can here comprise a first seed part conveyor for receiving and laterally displacing the seed parts removed by the rotatable removing unit of the seed part removing unit and/or a second seed part conveyor for transporting to the vehicle chassis the seed parts transported by the first seed part conveyor.

The first seed part conveyor preferably comprises a lateral conveyor belt extending substantially parallel to the rotatable removing element. The stripped seed parts fall onto the conveyor belt which discharges the seed parts in lateral direction, preferably to the side of the machine. The second seed part conveyor can there take over the function of discharging the seed parts from the conveyor belt. The second seed part conveyor comprises a flexible tube or hose and a fan, wherein the fan is configured to displace seed parts supplied by the first seed part conveyor through the tube or hose.

The second seed part conveyor can transport the seed parts to the self-propelling vehicle behind the picking element. A separating step can optionally be performed there in which the usable seed parts are separated from chaff, dust, air and the like.

In an embodiment of the invention the separating unit comprises at least one separating cyclone for separating supplied seed parts into the first and second stream by rotation. Further means for providing a separated first stream and second stream can be provided, although in determined embodiments the cyclone produces a sufficient degree of separation. In yet other embodiments, no cyclone is applied but the separation will take place in other manner.

In an embodiment of the invention the separating unit comprises a breaking unit for breaking supplied seed parts. A first stream and a second stream can be realized more easily after the seed parts are broken.

In an embodiment the separating unit comprises a dosing element for dosing the feed of the supplied, optionally broken seed parts to the second stream. In determined embodiments the separating cyclone can be dispensed with and there will for instance only be a dosing element or a breaking unit. In other embodiments the breaking unit and the dosing element are however combined into a single unit which fulfils both the breaking and the dosing function. It is possible here to envisage a rotatable combination roller in a housing, for instance a roller with radial protrusions which crush the seed parts against the inner side of the housing during rotation and which prevent the passage of seed parts when the rotation is stopped. By alternately rotating or stopping the combination roller the quantity and composition of the seed parts to be allowed to pass can be varied as desired.

In an embodiment of the invention the separating unit comprises a screen, particularly a vibratable screen. With the screen the relatively large seed parts can be collected and discharged in a second stream, while the smaller parts (and air) pass the screen and can be discharged as a first stream.

The seed parts can be collected and stored in a storage unit. The storage unit can for instance be mounted in optionally releasable manner on the chassis of the self-propelling vehicle. In determined embodiments the storage unit comprises a seed part receptacle. This receptacle can be mounted on the rear part of the vehicle so that the supplied seed parts can be stored in the receptacle all at once.

In order to transport the seed parts to the storage unit immediately or after at least one of a separating step, breaking step and dosing step, the processing machine is preferably provided with transport means for transporting the seed parts from a separating unit to a storage unit. In a determined embodiment these transport means comprise a screw conveyor (for instance a jack screw or Archimedes screw).

The picking unit for picking the fibre plants preferably comprises a picking element pivotable in up and downward direction. The pivotable picking element further comprises at least a pair of driven endless conveyor belts which are configured to grip the fibre plants and transport them therebetween toward the fibre plant conveyor on the vehicle chassis. Driving of the one or more pairs of endless conveyor belts can here take place by means of a number of drive pulleys which are driven by a single, central drive motor or by means of several drive motors.

For picking relatively short fibre plants such as flax it often suffices to apply a single picking element. In other embodiments, for instance embodiments wherein relatively long fibre plants are to be processed, use is made of two (or more) picking elements, a first or upper picking element for picking the respective upper parts of the fibre plants and a second or lower part for picking the respective lower parts of the fibre plants. In a determined embodiment the picking unit comprises a further picking element (under or above the above stated picking element) which is pivotable in up and downward direction. The further picking element is in principle similar to the stated picking element in terms of both construction and function. The further picking element can comprise at least a pair of driven endless further conveyor belts which are configured to grip fibre plants and transport them toward the fibre plant conveyor on the vehicle chassis. The free outer end of the picking element preferably lies at greater height than the free outer end of the further picking element for the purpose of engaging the fibre plants at two different heights. Embodiments with a single picking element are particularly suitable for processing relatively short fibre plants, such as flax, while embodiments with a (lower) picking element and an (upper) further picking element are particularly suitable for processing relatively long fibre plants, such as hemp.

In an embodiment of the invention the processing machine comprises cutting means for cutting the fibre plants to be picked into a lower fibre plant part and an upper fibre plant part, wherein the further picking element is preferably configured to engage lower fibre plant parts and the picking element is configured to engage upper fibre plant parts. In the case of the relatively long hemp the hemp plants can be picked and cut, after being deseeded, so that the remaining stems of the hemp plants can be placed down behind the travelling vehicle in two parallel swathes.

In a further embodiment the processing machine comprises a top cutting unit configured to cut respective top parts off the fibre plants. The top cutting unit is preferably arranged for cutting top parts off fibre plants from which the seed parts have already been removed by the seed part removing unit. In further preferred embodiments the device is embodied to first remove the seed parts from the fibre plants, then pick the fibre plants and only finally cut the top parts off the picked fibre plants with the top cutting unit (wherein the seed parts have thus already been removed from these top parts). In determined embodiments with two (or more) picking units the top parts (h₅) are first deseeded by the seed part removing unit, the fibre plants are then cut (for instance roughly in the centre) by the mowing unit 55 (resulting in an upper plant part h₂ and a lower plant part h₁), and the lower plant parts (h₁) of the fibre plants are finally picked.

In an embodiment the processing machine comprises a removing unit frame for supporting the removing unit, wherein the removing unit frame is preferably mounted on the vehicle chassis, the picking element or the further picking element. The removing unit frame can for instance be arranged on the upper side of the upper picking element in order to get the stripper to a desired height at the position of the seed parts. This removing unit frame is preferably also embodied pivotably relative to the vehicle chassis so that the height at which the removing unit engages on the fibre plants can be set as desired, and for instance even independently of the position of the picking elements.

In a particular embodiment the conveyor belts and/or the further conveyor belts are embodied to tilt the engaged fibre plants during transport, preferably tilt them from a substantially upright position to a substantially lying position. In this way the fibre plants can be placed on the ground in neat and controlled manner.

In determined embodiments the height of the seed part removing unit relative to the vehicle chassis can be adjusted with at least one actuator, for instance in that the actuator is formed by a lifting cylinder or similar actuator arranged between a removing unit frame and an upper picking element. In determined embodiments the processing machine comprises one or more lifting units for pivoting at least one of a first picking element, second picking element and seed part removing unit frame relative to a ground surface.

The one or more pivotable picking elements are preferably mounted with mounting means on the vehicle chassis such that they can be released (and in attached state enable pivoting of at least one of the picking frames), and can optionally be exchanged. A processing machine suitable for hemp processing can thus be converted easily and rapidly into a processing machine which is conversely suitable for flax processing, and vice versa.

According to another aspect, a method for processing fibre plants is provided, wherein the method comprises of removing seed parts from the fibre plants and then picking the fibre plants. The method is preferably performed by a processing machine of the type described herein and having the technical features described herein.

Removing the seed parts from a fibre plant with the seed part removing unit first and only then picking this fibre plant has a number of further advantages. The seed part removing unit holds the fibre plant taut and straight during removal of the seed parts, so that the picking unit can engage and can pick the fibre plant better. The yield of the deseeding is further found to be higher than when picking is done first and only then does deseeding take place. In this latter case a relatively great deal of seed loss occurs.

The exchangeable picking units, and preferably also the exchangeable pick-up unit, are preferably embodied to be carried wholly by the vehicle chassis of the vehicle. In other words, no wheels or other support means are arranged on the frame of the processing unit, for instance the picking unit or pick-up unit. The processing unit is supported only by the vehicle itself.

Further advantages, features and details of the invention will be elucidated with reference to the following description of some embodiments thereof. Reference is made in the description to the accompanying figures, in which:

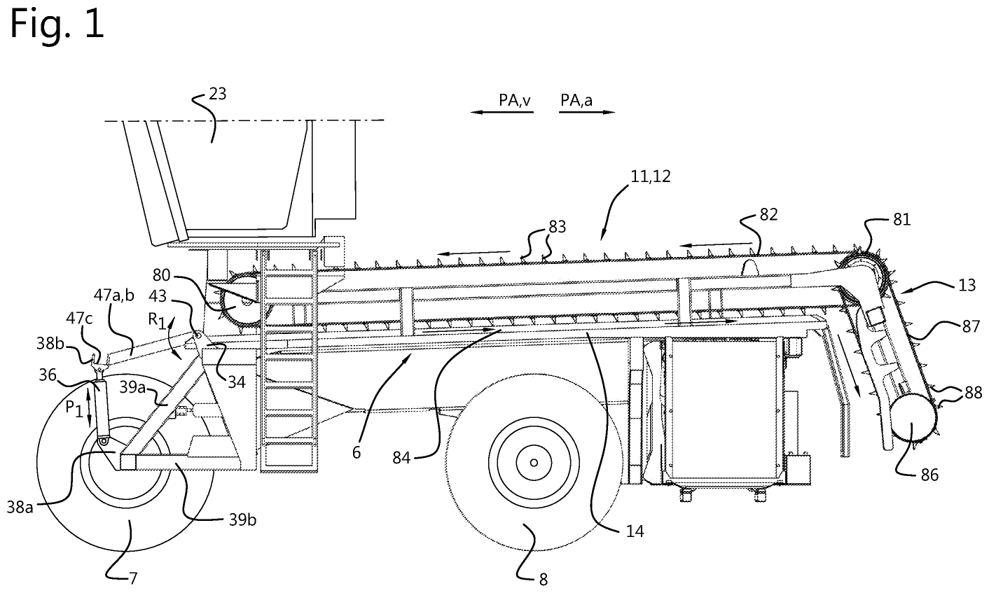

FIG. 1 is a partially cut-away side view of an embodiment of a vehicle according to the invention;

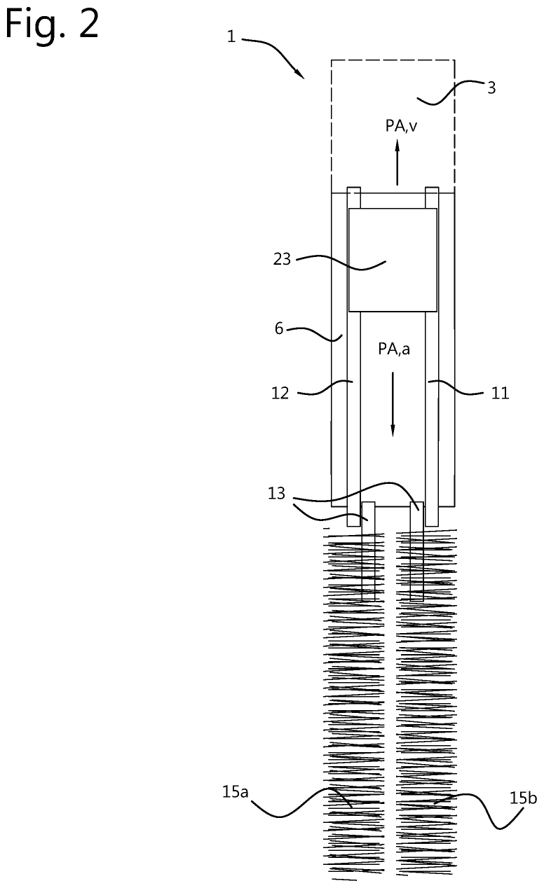

FIG. 2 is a schematic top view of the vehicle of FIG. 1, provided on the front side with a processing unit;

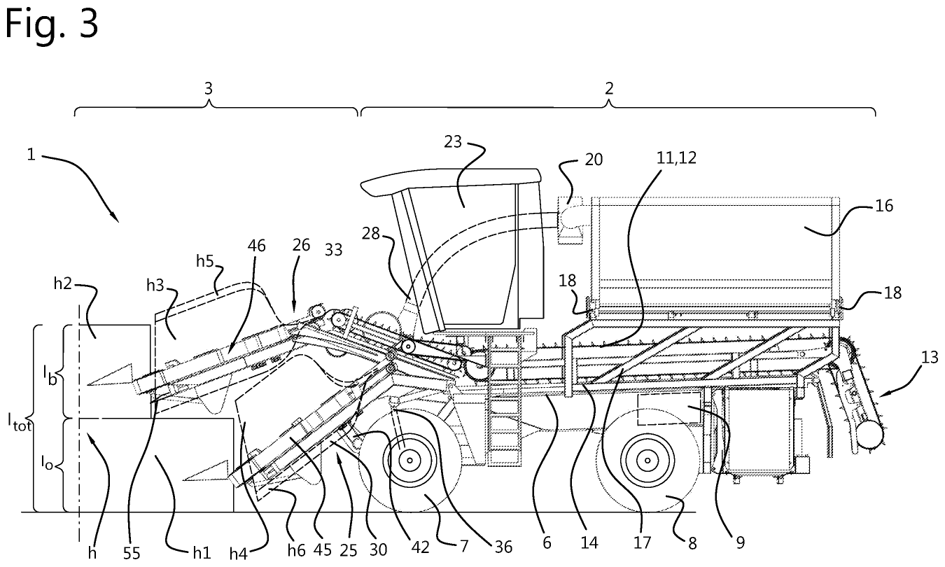

FIG. 3 is a side view of a processing machine according to an embodiment of the invention, wherein a processing unit 3 is mounted on vehicle 1 and is suitable for processing of long fibre plants;

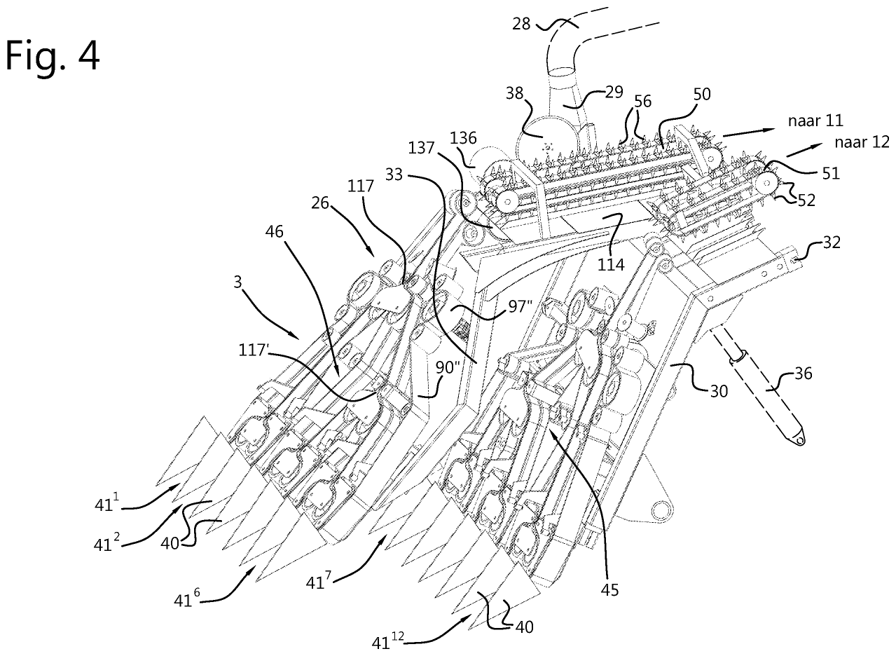

FIG. 4 is a detail view of an embodiment of a processing unit 3 according to the invention;

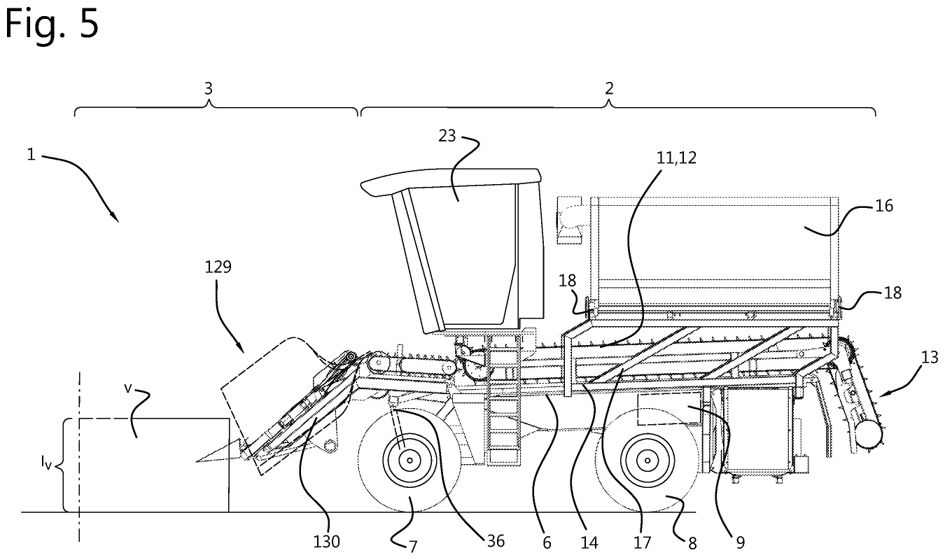

FIG. 5 is a side view of a processing machine according to an embodiment of the invention, wherein a processing unit 3 is mounted on vehicle 1 and is suitable for processing of short fibre plants;

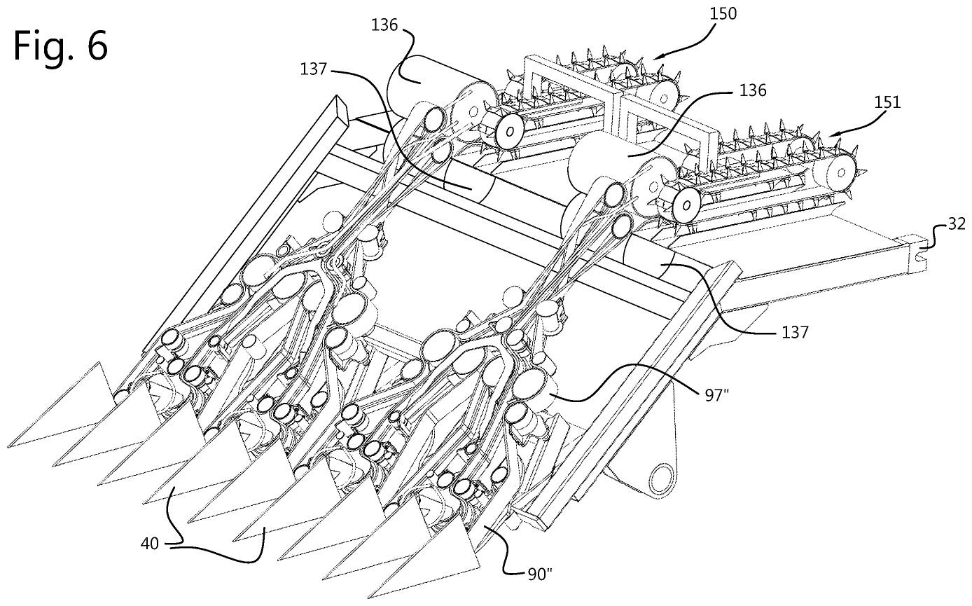

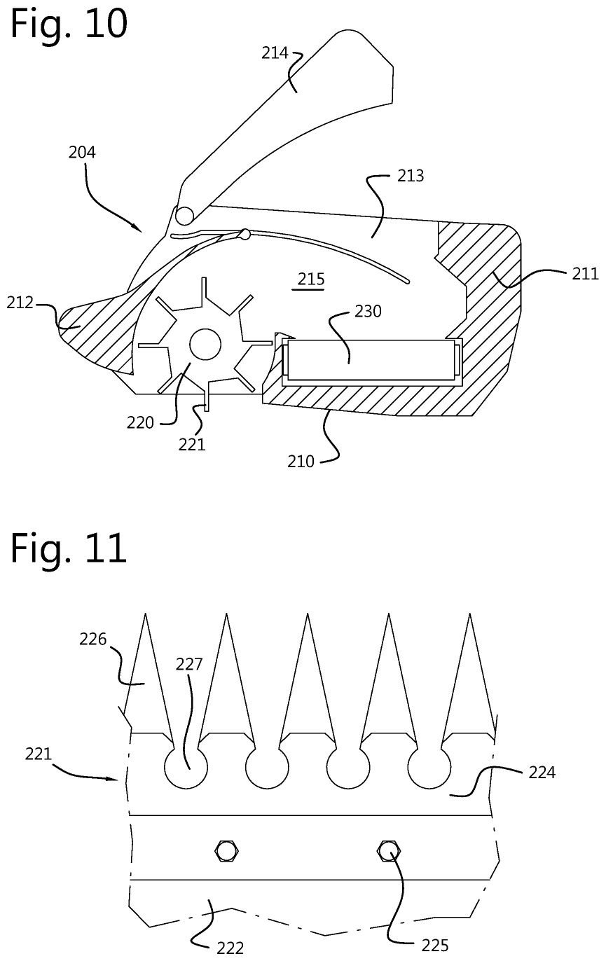

FIG. 6 is a detail view of the embodiment of FIG. 11;

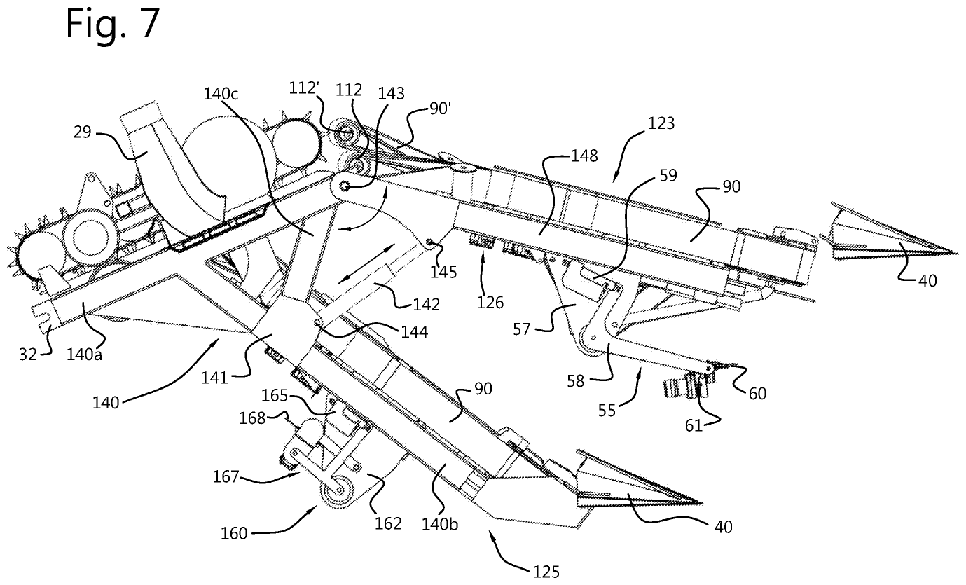

FIG. 7 is a side view of a further embodiment of the processing machine according to the invention, namely a side view of a further embodiment of a hemp picking unit with an alternative mounting of the picking elements on each other and on the vehicle chassis;

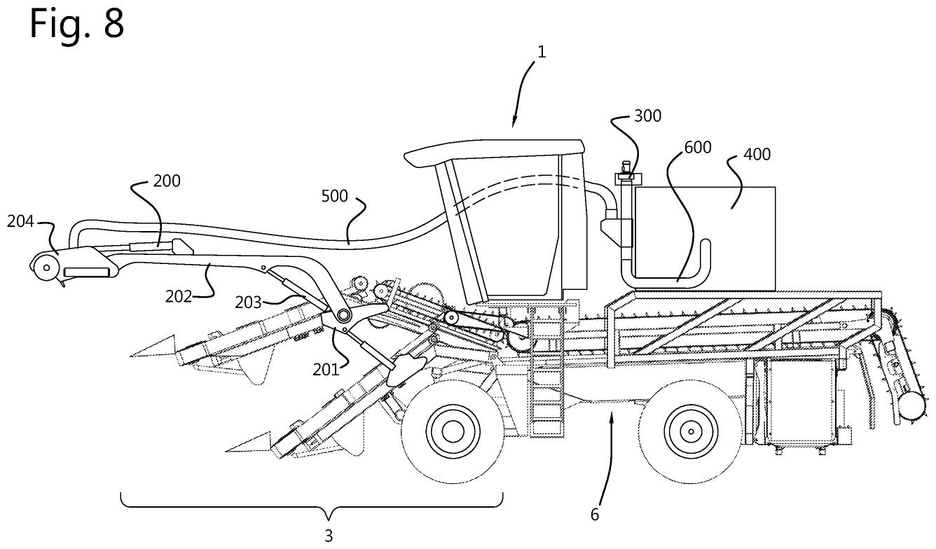

FIG. 8 is a side view of an embodiment of a processing machine with a seed part removing unit, suitable for processing hemp;

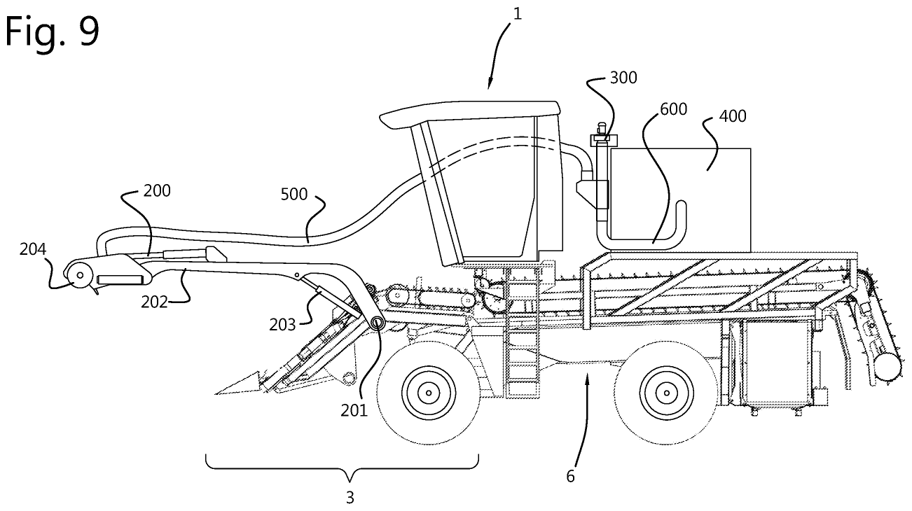

FIG. 9 is a side view of an embodiment of a processing machine with a seed part removing unit, suitable for processing flax;

FIG. 10 is a cross-section of an embodiment of a part of a seed part removing unit;

FIG. 11 is a detail of an embodiment of a number of teeth of a rotatable removing element;

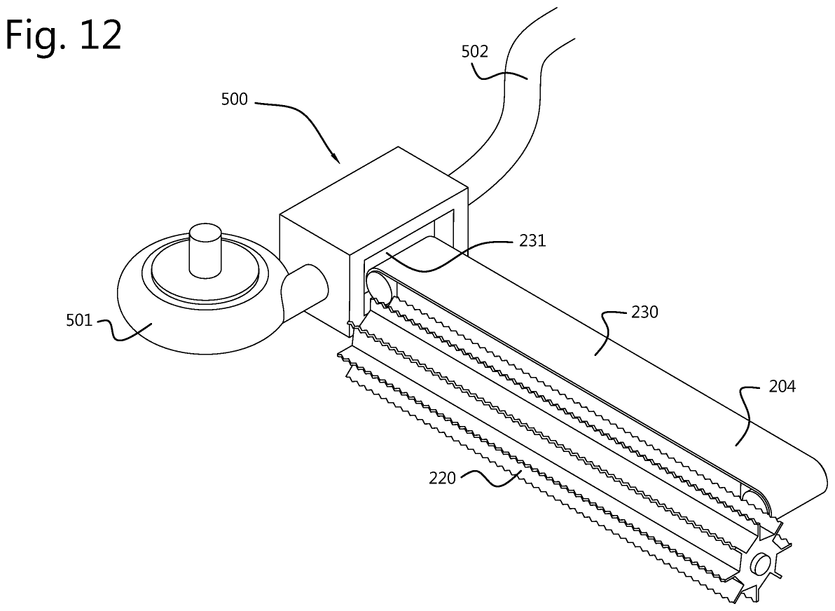

FIG. 12 is a partially cut-away perspective view of the embodiment of a seed part removing unit according to FIGS. 8-11;

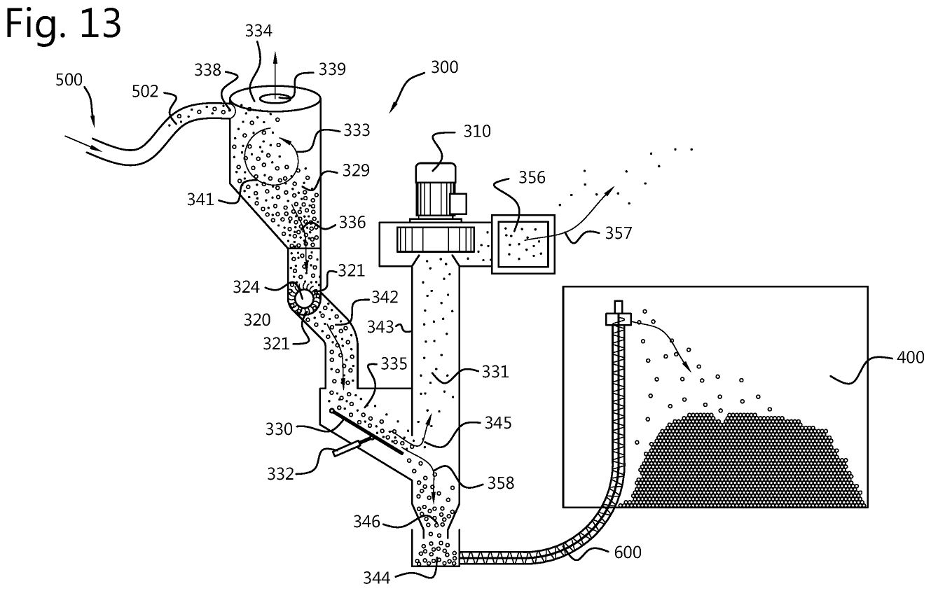

FIG. 13 is a cross-section of an embodiment of a separating unit, a storage unit and the transport means provided therebetween;

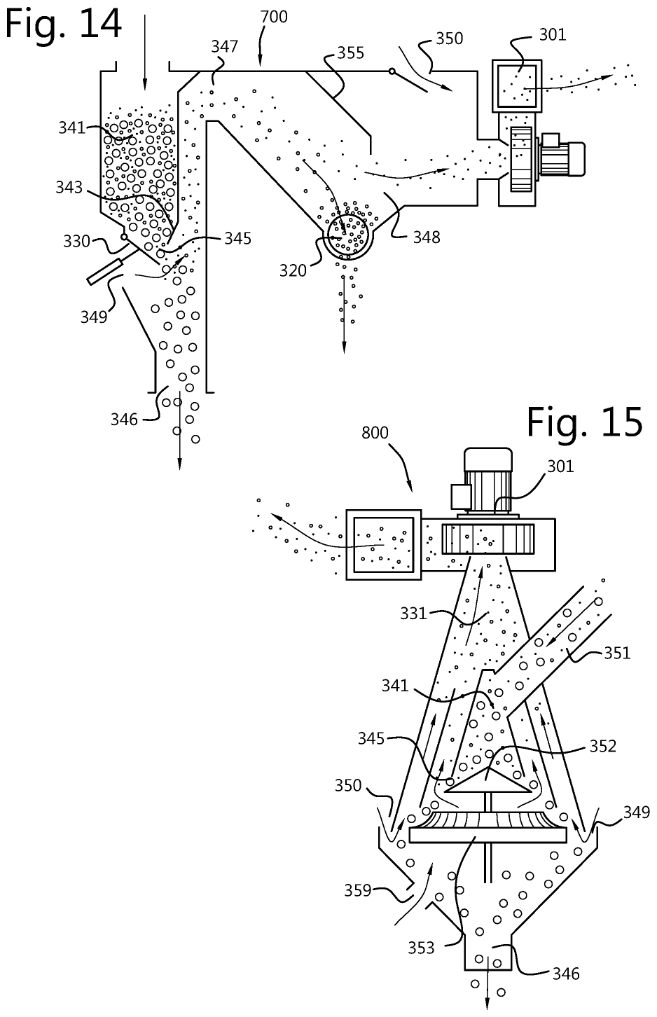

FIGS. 14 and 15 are cross-sections of alternative embodiments of a separating unit.

Flax is a fibre crop which is cultivated for making linen, among other things. The flax plant is usually between 80 and 120 cm long, and is harvested using a drawn or self-propelling flax picking machine. For this purpose the flax picking machine has on the front side a picking unit embodied specifically to pull the flax plants from the ground. The harvested flax plants are then processed by the flax picking machine by displacing them to the rear side of the flax picking machine and placing the flax plants on the ground surface during travel. The flax plants are placed flat on the ground in long rows, also referred to as “swathes”, wherein the stems of the harvested flax plants extend substantially transversely of the longitudinal direction of the swathes. This placing back of the flax flat onto the ground surface so that said swathes are created is also referred to as “depositing” or “picking up”. When the flax plants are placed in rows or swathes, an intermediate space is left between adjacent rows. These spaces are provided in order to prevent the swathes from becoming tangled in each other.

The harvested flax plants which were placed flat on the ground in swathes are then retted under the influence of a combination of dew, rain and sunlight. The retting of the flax by leaving the flax plants on the ground (i.e. a field or retting field) for some time is referred to in the field of processing flax as field retting or dew retting. In order to obtain a uniform retting and to prevent rotting of the flax, the flax placed flat on the ground in rows must be flipped over regularly. This flipping over of the flax placed flat on the ground is also referred to as “turning”. The turning of the flax is performed using a drawn or self-propelling flax turner.

Hemp is likewise a fibre crop which is cultivated for making textile fabrics or rope, among other things. The hemp plant is a lot longer than the flax plant. The hemp plant is characteristically between 140 cm and 240 cm in length. The hemp is usually cut at the base of the hemp plant and then processed further.

This would therefore already necessitate at least four different machines to enable optimal processing of both hemp and flax. This results in high purchase, use and maintenance costs. In embodiments of the present invention a processing machine is provided which is suitable in principle for harvesting/picking and/or turning relatively long fibre plants such as hemp or kenaf and relatively short fibre plants such as flax.

FIG. 1 shows a self-propelling vehicle 2 of a processing machine 1 according to a determined embodiment of the invention. Self-propelling vehicle 2 comprises a vehicle chassis 6 on which four wheels, i.e. two front wheels 7 and two rear wheels 8, are arranged in known manner. In FIG. 1 a part of the front left side of the vehicle has been cut away (i.e. the front left wheel and the relevant part of the wheel suspension) in order to obtain a better view of the construction of the vehicle on the front side. The vehicle is self-propelling, which means that it is provided with its own drive motor whereby a number of the wheels, for instance the two rear wheels, or all the wheels can be driven. The vehicle is steered from a driver's cab 23 on the front side of the vehicle. Chassis 6 comprises two parallel conveyors 11, 12 formed by a loading floor or platform 14 and two endless conveyor belts provided thereabove. At least one of the endless conveyor belts can here be adjusted in lateral direction so that the intermediate distance between the two conveyor belts can be adjusted, this in order to realize a suitable intermediate distance for shorter or longer swathes.

Referring to the top view of FIG. 2, the two conveyors 11, 12 are arranged along both longitudinal edges of vehicle 2 so that a quantity of fibre plants can be transported in axial rearward direction (P_{A,a}) with each of these. In the shown embodiment each of the conveyors 11, 12 comprises an endless conveyor belt 82 which runs on a front roller 80 and a rear roller 81. At least one of the rollers 80, 81 is driven via a drive (not shown). In a determined embodiment the drive comprises a hydraulic motor arranged in the rear (triple) pulley or roller 81. Each of the respective part-rollers of the multiple (triple) pulley is driven separately yet synchronously to each other, preferably according to a determined ratio as desired. So-called carriers 83 are provided on the outer side of conveyor belt 82. These can displace the fibre plants lying on platform 14, at least on guide rails 84 of the platform (FIG. 1), in said axial rearward direction (P_{A,a}) to the rear side of chassis 6. The fibre plants are thus enclosed here between conveyor belt 82 and guide rails 84.

On the rear side of vehicle 2 a delivering unit 13 is arranged for each conveyor 11, 12. In the shown embodiment the delivering unit 13 comprises an endless belt conveyor 87. The endless belt of each of the endless belt conveyors 87 is trained around a roller 86 and around said roller 81 (a belt conveyor 87 therefore sharing this with a conveyor 11 or 12). Driving of delivering unit 13 takes place the first roller 81. This extends obliquely rearward to some extent and is configured to displace the fibre plants coming from respective conveyor 11, 12 downward in dosed and controlled manner so that the fibre plants can be placed on the ground on the rear side of the vehicle. As shown in FIG. 2, when the vehicle moves in an axial forward direction (P_{A,v}), the fibre plants (v) picked or picked up on the front side of the vehicle will be displaced to the rear side of vehicle 2 and will each be placed down on the ground (o) in a separate row 15a, 15b via delivering units 13. In determined applications the rows 15a, 15b of fibre plants are composed of the same parts of the fibre plant, for instance in the case of the relatively short flax plants. In other embodiments the one row is however composed of the lower portions of the harvested fibre plants, while the other row consists of the upper portions of the harvested fibre plants. This is for instance the case when hemp plants are harvested. In both cases the fibre plants are placed flat on the ground, parallel to each other as far as possible, after which said retting can commence.

Vehicle 2 is provided with a processing unit 3 on its front side in order to be able to pick the fibre plants or to be able to pick fibre plants already placed flat on the ground at an earlier stage back up again. A picking unit is arranged on the front side in the case that the fibre plants are being picked, while a processing unit 3 will be a pick-up unit in cases where fibre plants which have already been picked and placed on the ground previously are being picked up. A different picking unit will further be mounted on the vehicle depending on the length of the crop to be picked.

Referring to FIG. 1 in particular, the chassis comprises on the front side of chassis 6 of vehicle 2 a number of support chassis parts 39a, 39b. The support chassis parts 39b extend in line with the rest of chassis 6 of vehicle 2, while the support parts 39a mounted on support parts 30b and the rest of chassis 6 are disposed obliquely. Chassis 6 is further provided with a number of hinges 48 on which two parallel longitudinal lifting arms 47a, 47b are arranged. Both longitudinal lifting arms 47a, 47b are connected at their outer ends to a transverse lifting arm 47c. The support chassis parts 39a, 39b, longitudinal lifting arms 47a, 47b and transverse lifting arm 47c together form a strong and stable support structure for mounting a number of actuators whereby a processing unit 3 coupled to the chassis 6 of vehicle 2 can be pivoted upward and downward. Together with these actuators the support structure forms the above stated lifting unit.

The pivoting of processing unit 3 is brought about by a number of actuators, for instance electric motors or, preferably, lifting cylinders 36, of the lifting unit. In FIG. 1 the actuators are formed by two lifting cylinders 36. In the shown embodiment two lifting cylinders positioned laterally adjacently of each other are provided. In other embodiments use is however only made of a single lifting cylinder, or three or more lifting cylinders are applied. The lifting cylinders are mounted pivotally on the support chassis parts 39a, 39b via hinges and on transverse lifting arm 47c via a mounting support 38b. A further description of the construction of the lifting unit and of the operation thereof will follow below.

Chassis 6 is provided on either side of the support chassis parts 39a, 39b with first mounting means 34 for mounting a processing unit 3 thereon in pivotable and releasable manner. The first mounting means 34 can be embodied in numerous ways, but in the shown specific embodiment comprise a number of flanges in which respective pivot shafts 43 can be rotatably mounted.

Each of the different processing units 3 comprises one or more frame parts which can be mounted in pivotable and releasable manner on said first mounting means 34. In the embodiments shown in FIGS. 3 and 4 the processing unit 3 comprises a first, lower hemp picking element 25 and a second, upper hemp picking element 26 placed thereabove. The lower hemp picking element comprises a frame part 30 which can be mounted pivotally and in easily releasable manner on first mounting means 34 of the vehicle using second mounting means 32. The upper hemp picking element 26 comprises a frame part 33 which also takes a pivotable (yet not necessarily easily releasable) form, albeit that in the shown embodiment frame part 33 of the upper hemp picking element 26 is mounted on the frame part 30 of the lower hemp picking element 25 instead of directly on chassis 6 of the vehicle. In other embodiments (not shown) it is however precisely the upper hemp picking element that is mounted on chassis 6 of vehicle 2, and the lower hemp picking element on the upper hemp picking element. In still further embodiments (not shown) the two hemp picking elements are mounted pivotally and releasably on vehicle 2.

For mounting on the chassis 6 of vehicle 2, more particularly on the first mounting means 34 thereof, such as the flanges 34 positioned on or close to the sides of vehicle 2 and having the pivot shafts 43 mounted therein, the processing unit 3, in the shown embodiment the lower hemp picking element 25, is provided with second mounting means 32. The second mounting means 32 are embodied for easy mounting on first mounting means 34. The first and second mounting means 34, 32 together form a mounting hinge between processing unit 3 and vehicle 2, such that processing unit 3 can be pivoted in up and downward direction around the lying pivot shafts 43.

To make processing unit 3 pivot relative to vehicle 2 the above-described lifting unit is utilized. As described above, the lifting cylinders 36 are arranged rotatably on the flanges 38a of chassis 6 at one outer end. On their opposite sides the lifting cylinders 36 are coupled via mounting supports 38b to the transverse lifting arm 47c. Transverse lifting arm 47c of the lifting unit has a substantially U-shaped cross-section, which is clearly visible particularly in FIG. 1. The U-shape forms a receiving space for a part of the frame part 30 of the lower hemp picking element 25. In other words, the processing unit 3 can be connected to the lifting unit in simple manner by placing frame part 30 of lower hemp picking element 25 into the transverse lifting arm 47c of the lifting unit from above or, conversely, by simply pressing transverse lifting arm 47c against frame part 30 from below. Finally, the whole is locked by a locking mechanism 70, for instance in the form of a remotely controllable extending cylinder which in extended state ensures that processing unit 3 remains locked to the lifting unit. The lifting unit is then ready to lift processing unit 3.

As shown with arrows (P₁) in the figures, the length of lifting cylinders 36 is controllable. It will be apparent that when the length of lifting cylinders 36 is increased, frame part 30 will pivot upward, while frame part 30 will pivot downward if the length of lifting cylinders 36 is reduced. In this way the height of the free end of the processing unit can be varied, for instance in order to adjust the position in which the processing unit grips the fibre plants and pulls them from the ground during travel of the vehicle.

The mounting means of each of the different processing units 3 are essentially identical. This means that the different processing units can not only be easily mounted on and detached from the vehicle, but that this can also take place in a uniform manner. It is noted here that when processing units 3 are exchanged, only the mounting means of processing unit 3 (i.e. the second mounting means 3 when the processing unit is a picking unit for long fibre plants, fifth mounting means when the processing unit is a picking unit for short fibre plants and sixth mounting means when the processing unit is a turning unit for turning long or short fibre plants) need in fact be released from the first mounting means of the vehicle, after which processing unit 3, particularly the frame part 30 thereof, can be removed from the upper side of cylinder 36. By now simply pacing another processing unit 3 on the lifting unit of vehicle 2 and mounting the associated mounting means on the first mounting means of the vehicle, the user can easily make processing machine 1 suitable for the specific desired process, such as picking of short fibre plants, picking of long fibre plants or picking up and turning fibre plants.

As described above, FIGS. 3 and 4 show an embodiment of a processing machine 1 according to the invention wherein the processing machine is provided with an exchangeable picking unit comprising a first picking element and a second picking element placed thereabove. The embodiment is embodied for picking of relatively long fibre plants, such as hemp plants, as shown schematically in the figure.

In the shown embodiment the processing machine 1 comprises the above stated self-propelling vehicle 2 and a specific processing unit 3, i.e. a hemp picking unit. The hemp picking unit comprises a lower hemp picking element 25 and arranged thereabove an upper hemp picking element 26. The lower picking element 25 is mounted on the first mounting means of the vehicle in the above stated manner, this such that the first hemp picking element 25 can be pivoted in upward and downward directions by controlling said lifting cylinders 36. The upper hemp picking element 26 is pivotally arranged via pivot shafts 43 on the lower hemp picking element 25 so that the upper hemp picking element 26 can be pivoted (pivoting directions R₂) relative to the first hemp picking element 25 (and relative to vehicle 2 and the ground surface). The pivoting movement of the upper hemp picking element 26 relative to the lower hemp picking element 25 is driven by a number of further lifting cylinders 42 arranged on frame parts 30, 33, wherein increasing the length of lifting cylinders 42 results in an upward rotation of the upper hemp picking element 26 relative to the lower hemp picking element 25, while reducing the length results in a downward rotation of the upper hemp picking element 26 relative to the lower hemp picking element 25.

FIG. 3 shows schematically that the relatively long fibre plants (h), such as hemp, kenaf or similar fibre plants, have an overall length lₜₒₜ (characteristically between 1.4 and 4.0 metres, 2.4 metres on average). The lower part (h₁) of each of the fibre plants (h) has a length lₒ (for instance 110 cm to 120 cm), while the upper part (h₂) has a length l_{b} (for instance 120 to 130 cm). In the shown embodiment both lengths lₒ and l_{b} are roughly the same, although in practice these lengths may of course differ. What is important is only that the fibre plants (h) are cut into at least two parts (h₁, h₂) and then processed further by processing machine 1. Said lower hemp picking element 25 is for this purpose made suitable for picking and processing the lower fibre plant parts (h₁), while the upper hemp picking element 26 is intended for picking the upper fibre plant parts (h₂).

The upper hemp picking element 26 comprises a transport installation 46 for gripping hemp plants and transporting them to vehicle 2, while the lower hemp picking element 25 comprises a (preferably wholly or almost wholly identical) transport installation 45 whereby hemp plants can likewise be gripped and transported to vehicle 2. When vehicle 2 travels in a forward direction (P_{A,v}), the upper hemp picking element 26 will reach the hemp plants first. After a short time interval the lower hemp picking element 25 will also reach these same hemp plants. In other words, the engaging position at which the upper hemp picking element 26 engages a determined hemp plant at a determined point in time is shifted relative to the engaging position at which the lower hemp picking element 25 engages a (different) fibre plant at the same point in time. This has the result that the upper hemp picking element 26 first engages the upper part (h₂) of the hemp plants and cuts them loose from the lower part (h₁) with a cutting element 55 (also referred to here as mowing element 55) provided on the front side of the upper hemp picking element 26, while it is after this, so only when upper part h₂ has been cut loose and is already being carried away, that the lower hemp picking element 25 will engage on the lower part (h₁) of the same hemp plant.

The lower hemp picking element 25 is configured to engage the lower part (h₁) of the hemp plant. As a result of the forward movement of vehicle 2 and/or as a result of displacement by means of the transport installation 45 to be described further below the hemp plants are pulled from the ground along with the roots. It is therefore noted that the lower part of a hemp plant is in principle not cut loose from the roots before the hemp plant has been pulled from the ground as a whole.

As shown in FIG. 3, the gripped upper part (h₂) of a hemp plant (h) which has been cut loose with mowing element 55 is picked up by the upper hemp picking element 26. This upper part (h₂) of the fibre plant comprises a top, flower or plume portion (h₅) and a remaining upper portion (h₃). As will be elucidated below, in determined embodiments the top portion (h₅) of the upper part (h₂) of the hemp plant (h) will be removed using a cutting unit. The top portion (h₅) is here discharged via discharge means comprising a discharge pipe 28 with an inlet opening close to the cutting unit, a centrifugal fan 20 connected to the discharge pipe and an outlet opening to a receptacle 16 arranged via a frame 17 on the rear side of vehicle 2. As shown in FIG. 3, this receptacle 16 is releasably mounted via rapid couplings 18 on a frame part of frame 6 and will essentially only be used when the intention is to remove the top portions (h₅) from a fibre plant. In other words, when the top portion is not cut off, receptacle 16 can optionally be dispensed with.

The lower part (h₁) of a hemp plant (h) is similarly composed of a root portion h₆ where the roots of the hemp plant are located and a remaining lower part h₄. In determined embodiments the root portion h₆ will be removed from the lower part h₁ of the hemp plants (h) by means of a root cutting unit. These removed root parts h₆ can be discharged to the receptacle 16 on the vehicle, although they are preferably dropped (in a manner which is not further described) directly onto the ground (o). In a determined embodiment the cutting unit and the associated discharge means of the root portions (h₆) are embodied such that these portions come to lie directly in front of one or more of the wheels 7, 8. This has the result that when vehicle 2 advances, the cut-off root portions h₆ are compressed or even pressed into the ground under the weight of the tyres of wheels 7, 8. In other words, in this embodiment the roots are pressed into the ground and the tops are collected in receptacle 16, which has the result that the delivering units 13 place only the lower remaining parts (h₄) and the upper remaining parts (h₃) of a hemp plant (h) onto the ground (o) on the rear side of the vehicle. As further elucidated elsewhere, in determined embodiments the two delivering units 13 are configured to place a first row 15a of only lower remaining parts (h₄) of the hemp plant and a second row 15b of only upper remaining parts (h₃) of the hemp plants (h) onto the ground and then have them undergo the desired retting process (FIG. 2).

FIG. 4 shows a view of hemp picking unit 3. This figure shows the transport installations 45, 46 whereby the hemp plants are gripped and transported to vehicle 2. Each of the transport installations 45, 46 comprises a number of endless belt conveyors, more particularly a first number of endless belt conveyors for gripping the crop, transporting it and tilting the crop during transport, and a second number of endless belt conveyors for receiving the crop from the first number of belt conveyors and transporting the crop to the conveyors on vehicle 2. The second number of conveyors (characteristically 3, 4 or more) is here usually smaller than the first number of conveyors (characteristically 1 or 2).

Guide elements 40 are provided on the front side of both the lower hemp picking element 25 and the upper hemp picking element 26. Their object is to make it possible to be able, when the vehicle and the picking unit 3 mounted thereon are advanced, to push the hemp plants (h) to the side and guide them into a number of, in FIG. 4 six per hemp picking unit (although this can also be a greater or smaller number in other embodiments), passages 41¹-41⁶ for the upper hemp picking element 26 and passages 41₇-41¹² for the lower hemp picking element 25, all configured to receive and grip the hemp plants. These twelve passages are formed by a number of driven conveyor belts and a number of pulleys.

The figures show embodiments of the transport installations 45, 46 in which different endless belt conveyors are used for temporarily supplying a number of hemp plant streams. Parts of endless belt conveyors are here preferably used in combination in order to thus achieve an efficient use of the space available on the picking elements and/or to limit the complexity and thereby the costs of the transport installations. It is for instance shown in the drawings that a converging area, wherein two (or more) streams of hemp plants converge, is defined roughly halfway between the entry of the hemp plants on the front side of each of the transport installations 45, 46 and the delivery of the plants on the rear side of transport installations 45, 46 to vehicle 2.

FIG. 4 shows the operation of transport installation 45 and particularly the turning over of the hemp plants in more detail. The two streams of hemp plants which enter via passages 41¹ and 41² converge between the conveyor belts. The hemp plants (h₂) are then transported on between the conveyor belts and, after having passed the driven pulley or roller 96, reach said collecting area 117. FIG. 5 shows an embodiment where the combined streams of passages 41¹ and 41² on one side and the combined streams of a number of other passages on the other converge in collecting area 117.

The horizontally oriented hemp plant parts (h₂=h₃+h₅) reaches the endless belt conveyor 50. The cut-off hemp plants (h₂) are enclosed between the underside of the endless belt conveyor 50 and the upper side of a number of upright guide flanges 150 on frame part 33 and transported toward vehicle 2. During this transport the hemp plants (h₂) are processed by pressing (rolling) them and by cutting the top portions (h₅) off the pressed hemp plants (h₂) and discharging them. The lying hemp plants (h₂) are first guided between an upper pressing roller 136 and lower pressing roller 137 so that at least the relevant tops (h₅) (these often taking the form of a plume) are pressed. These pressed top portions (h₅) of the hemp plants (h₂) are then cut off via a top cutting unit 38. This top cutting unit 38 is represented in highly schematic manner as a vertically arranged rotatable blade (in the shown embodiment a circular knife, although the blade can also have a different, for instance an elongate, form). The housing around this circular knife, the drive of the rotation of the circular knife and guide means for displacing the circular knife in lateral direction P_{L} are not shown. The cut-off top parts (h₅) of the hemp parts are extracted via the extraction means 29, for instance a collecting mouth 29, connected to an extraction pipe 28 and a centrifugal fan 20, and blown into the receptacle 16 on the rear side of vehicle 2 for storing the top parts therein.

The picking and further processing of the upper parts (h₂) by means of the upper picking unit 26 is described in detail with reference to FIG. 5. The lower parts (h₁) of the hemp plants (h) are similarly picked and further processed by the lower hemp picking element 25. A detailed description of the way in which these lower parts (h₁) of the hemp plants are gripped and processed can therefore be dispensed with. The lower hemp parts (h₁) are gripped and carried along in similar manner by a transport installation 45, rotated through a half turn until they are in horizontal position and then discharged by a conveyor 51.

In the above stated embodiments the processing machine 1 is geared toward processing relatively high/long crops, such as hemp. In other embodiments processing machine 1 can be made suitable in very simple manner for processing shorter/less high crops, such as flax. For this purpose hemp picking unit 3 consisting of at least the upper and lower hemp picking elements 25, 26 is replaced with a flax picking element 129 which is embodied specifically to process this lower crop. The height of the crop, such as flax, is usually between 80 cm and 120 cm (lₜₒₜ=80−120 cm).

As shown in FIGS. 5 and 6, the flax picking element 129 comprises a chassis frame part 130 which is provided with essentially the same mounting means as the above stated lower hemp picking element 25 of the hemp picking unit. Frame part 130 can for instance be mounted on the pivot shaft of the first mounting means 34 of vehicle 2 in simple manner with said mounting means 32. This flax picking unit can be placed on the transverse lifting arm 47c of the lifting unit of vehicle 2 in manner similar as the hemp picking unit so that lifting cylinders 36 can pivot frame 130 of the flax picking element in upward and downward direction. The present flax picking unit essentially uses the same techniques to grip this fibre plant, in this case flax, pull it from the ground and transport it toward vehicle 2, and to change the position of the crop during transport toward vehicle 2. Use is for this purpose once again made of a transport installation which is once again constructed from the above-described endless belt conveyors, among other things. A difference with the hemp picking unit is however that the flax picking unit provides the option and space to realize a plurality of passages adjacently of each other. While there are six passages per hemp picking element (so a total of twelve passages, although this number can also be increased or reduced in other embodiments) in the hemp picking unit, there are eight passages in the embodiment of FIG. 5, these all being positioned adjacently of each other. The four passages on the left receive flax and this flax is carried via a first conveyor 150 to the first conveyor 11 on vehicle 2, while the four passages on the right are used to carry the remaining flax plants via a second conveyor 151 toward the second conveyor 12 of vehicle 2. The two conveyors 150, 151 are here situated adjacently of each other instead of above each other, as was the case in the hemp picking unit.

FIG. 5 further shows that the flax, at least the upper part thereof, is once again pressed by two pressing rollers 136, 137 in determined embodiments. In determined embodiments the seed parts (particularly the bolls, seed capsules) are once again cut off, whereas in other embodiments the cutting off does not take place. These pressing rollers 136, 137 and/or this cutting unit are otherwise also optional, and in determined embodiments they are therefore dispensed with.

FIGS. 3 and 4 show embodiments of picking units for picking relatively long fibre plants, such as the hemp picking unit, and FIG. 5 a picking unit for picking relatively short fibre plants. These are however merely specific examples of processing units which can be mounted on vehicle 2 and removed from vehicle 2 in the above stated simple manner. Another example of such a processing unit is a pick-up unit. As already described above, the fibre plants are placed down flat on the ground on the rear side of the vehicle after having been picked and rotated. These fibre plants are then left on the ground for some time so that a retting process takes place. To enable retting to take place properly and uniformly, the fibre plants on the ground surface must however be turned over at regular intervals. This turning over can likewise be performed with the same processing machine 1, wherein a so-called pick-up unit is then however arranged as processing unit 3. The previously used picking unit, for instance flax picking unit or hemp picking unit, is exchanged for a pick-up unit which is configured to pick up the crop lying flat on the ground, rotate it through 1800 and place it back onto the ground in overturned state on the rear side of the vehicle. This turning over of these picked-up fibre plants can once again take place in similar manner using endless conveyor belts between which the fibre plants are gripped. Conveyor belts are here placed such that the fibre plants are rotated through a half turn instead of a quarter turn. The fibre plants reach the vehicle in the overturned (half turn) state and can be transported toward the delivering units in known manner by the vehicle. This application requires in principle no modifications on vehicle 2 either to make it suitable for picking up and turning the fibre plants. This means that the processing machine is not only suitable for picking fibre plants of different lengths (i.e. relatively long fibre plants such as hemp or relatively short fibre plants such as flax), but is also suitable for picking back up, wholly turning over and placing back onto the ground surface fibre plants after they have been picked and placed down on the ground. In other words, the proposed processing machine is not only a picking machine but also a turning machine. It will be apparent that the costs of processing the fibre plants can hereby be limited to considerable extent and an extremely versatile processing machine can be realized.

FIG. 7 shows a further embodiment of a processing unit 113 for picking relatively long fibre plants, such as hemp. Processing unit 113 has a pivotable upper picking element 123 and a pivotable lower picking element 125. The lower picking element 125 comprises a frame 140 and the upper picking element 123 has a frame 148. The frame 140 of the lower picking element 125 has a first frame part 140a which can be mounted pivotally on vehicle chassis 6 in the known, above described manner using the fifth mounting means 32a. This first frame part 140a can be pivoted in upward and downward direction using the above described lifting unit comprising a number of lifting cylinders 36. Formed integrally on frame part 140a is a second frame part 140b. Second frame part 140b lies here at an angle (characteristically of about 45 degrees) relative to first frame part 140a. A third frame part 140c is further formed between the first and second frame parts 140a, 140b. This third frame part 140c functions as support for the first and second frame parts and ensures that the two frame parts keep extending at said angle under heavy load as well. Second frame part 140b further comprises a number of support flanges 141 on which a number of lifting cylinders 142 are mounted. Lifting cylinders 142 are pivotally coupled with their outer ends via respective hinges 144 and 145 to the second frame part 140b of the frame 140 of lower picking element 125 and to the frame 148 of upper picking element 123. By increasing or reducing the length of lifting cylinders 142 (see arrows) the upper picking element 123 can be pivoted respectively upward and downward.

FIG. 7 also shows an embodiment of the above stated root cutting unit 160 and the cutting unit or mowing unit 55 on the front side of the upper picking element 123. The root cutting unit 160 is positioned on the underside of lower picking element 125 in order to cut the root portions (h6) off the flax plants (h) pulled from the ground and transported therealong by the endless belt conveyor 90. Root cutting unit 160 comprises two supports 160, 160′, mutually connected with a support arm 166, wherein a lying (horizontal) cutting part (not designated) is arranged between the two supports 160, 160′. The cutting part is provided with two circular knives 168, 168′ which can be rotated via respective root cutting unit drive motors (not designated). In this embodiment the root portions cut off by the rotating circular knives 168, 168′ drop directly downward and end up on the ground. In other embodiments (not shown) a provision is also made to have the cut-off root portions drop to the ground at a specific lateral position, for instance at one or more lateral positions directly in front of at least one of the two front wheels 7. It is further shown that the height of cutting part can be adjusted relative to the rest of the first picking element by controlling an actuator 165, for instance an electric motor or a hydraulic lifting cylinder, which drives the rod system 167 on which the cutting part is mounted. A single actuator can be provided, for instance mounted on support 160 or support 160′, although in other embodiments an actuator is provided at both outer ends of cutting part. The rods of rod system 167 are mounted rotatably on the support 160, 160′, this such that by pushing against or pulling on the upright rod of the rod system the rods are set into rotation and in this way move the cutting part respectively upward and downward.

FIG. 7 also shows the cutting or mowing unit 55 already described above with reference to FIG. 3. The cutting unit 55 in FIG. 3 was mounted on the underside of the frame 33 of the upper picking element 26.

Cutting unit 55 comprises two support cheeks 57, 57′ provided on the underside of frame part 148. Respective L-shaped supports 61, 61′ are mounted rotatably (via rotation shafts 58) on the two support cheeks 57, 57′. The rotation movement of the two L-shaped supports is realized by an actuator 59, for instance an electric motor 58 mounted on the relevant support cheek 57, 57′. Rotation of the L-shaped supports 61, 61′ provides for upward or downward movement of an elongate cutting element. The height of the cutting unit relative to the rest of the picking element and thereby the height of the cutting unit relative to the ground surface can hereby be adjusted as desired.

The actuator is preferably remotely controllable, for instance from the driver's cab 23 (FIG. 3), so that the height of the cutting unit relative to the rest of the picking element can be adjusted remotely, for instance during travel of the vehicle or just before a quantity of fibre plants of a determined length will be picked.

In the shown embodiments the cutting element is constructed from a (horizontal) row of mutually reciprocally displaceable blades 60 in which a large amount of fibre plants can be cut, this row extending over a substantial or substantially whole width of the upper picking element. The reciprocal displacement of the blades of such a cutting unit is driven by a motor 61, for instance an electric motor and a suitable transmission mechanism.

Because the processing machine is in determined embodiments of the invention able to adjust the position/orientation of the processing unit 3 (more particularly adjust the pivot position of the flax picking element of the flax picking unit, the pivot positions of both the upper picking element and the lower picking element of the hemp picking unit, the pivot position of the pick-up unit, the height of cutting unit/mowing unit 55, the position (height) of root cutting unit 160 and/or the (lateral) position of top cutting unit 38) and because this position adjustment (in height direction and lateral direction) further preferably takes place during travel and processing of the fibre plants, it is possible to optimally anticipate the local conditions in the field, for instance a varying height of the fibre plants, a varying orientation of the ground surface, and the like. This varying of the height and/or lateral cutting position can be controlled manually via suitable operating elements in driver's cab 23. In further embodiments this is however done by means of an electronic control unit, for instance a computer. This can be connected to one or more sensors, such as a camera, whereby the height (and/or other parameters) of the fibre plants can for instance be measured. The electronic control unit can then (before the fibre plants are processed or during processing thereof, so while travelling) control one or more of the processing unit (i.e. one or more of the flax picking element, upper picking element, lower picking element and pick-up unit), the root cutting unit and the top cutting unit on the basis of the measurement signals of the one or more sensors and on the basis of a predetermined control algorithm. The adjusting can take place dynamically, which means that the control is performed continuously or periodically with a short time interval, so as to thus always have the processing machine in an optimal position during travel. An additional advantage is that, even when the height of the fibre plants varies, the control unit controls at least one of the flax picking element, the upper picking element, the lower picking element, the pick-up unit, the root cutting unit and/or the top cutting unit such that the swathes on the rear side of the vehicle come to lie neatly aligned behind the vehicle relative to the centre line. More particularly, the control unit can be configured to match the centre lines of the two swathes to the centre line of the picking element and to control the cutting units and/or the picking units on the basis thereof.

FIG. 8 shows a side view of a processing machine 1 according to an embodiment, comprising a processing unit 3 comprising a picking unit with two picking elements (a lower picking element 125 and an upper picking element 126, see also FIG. 7), and further a removing unit 200, a separating unit 300 and a storage unit 400. In the shown embodiment the picking unit is equipped with third mounting means 201 for mounting of a removing unit, which are in this case provided on the upper picking element. The removing unit can preferably be mounted releasably on the picking unit. This ensures that the picking unit can be used both with and without the removing unit, and that the two forms of use can be alternated relatively easily. The separating unit 300 and the storage unit 400 are preferably also releasably mounted so that they can be removed or placed as needed for the desired application of the processing machine 1

Removing unit 200 is configured to remove parts of the fibre plants situated substantially on the upper side of the fibre plants, i.e. seed parts such as bolls and possible other parts such as leaves. The shown removing unit is arranged for removing said plant parts prior to or substantially at the same time as the picking for the purpose of achieving a maximally predictable separation of the plant parts and the stems to be removed. In a later processing step the removed seed parts can for instance be pressed into hemp oil, be used directly as food, or be used to obtain cannabidiol (CBD). Removing such seed parts further produces a purer product consisting of the stems (and optionally roots) of the fibre plant. These stems can be used to obtain fibres and/or wood-like parts.

In the shown embodiment the removing unit 200 comprises a seed part removing unit frame 202 and fourth mounting means 203 for mounting the removing unit frame 200 releasably on the picking unit. In this embodiment the removing unit is supported wholly by the picking unit. In other embodiments the removing unit frame can be mounted directly on the vehicle chassis so that the weight of removing unit 200 is supported directly by the vehicle 1 itself.

The height of seed part removing unit frame 202 can be adjusted by pivoting the pivoting unit up and downward. In the shown embodiment this means pivoting the upper picking element 126 up and downward, for instance by operating the above described lifting cylinder(s) 142. In determined embodiments the seed part removing unit frame 202 is also embodied for pivoting in up and downward direction. The fourth mounting means 203 can for instance comprise a hinge 208, wherein driving of the pivoting movement is realized by an actuator 209, for instance by a hydraulic lifting cylinder. The head 204 to be described further can further also be mounted pivotally on the seed part removing unit frame 202, wherein the pivoting movement can be driven by an actuator 216 (for instance a hydraulic cylinder).

The height of the head 204, to be described further, of a rotatable removing element of removing unit 200 relative to the ground can for instance be adjusted to the growth height of the fibre plants which are to be picked and from which specific portions must be removed, or to determined tolerances of the intended product, for instance a determined ratio of material loss to completeness of removal of the seed parts.

FIG. 8 further shows a separating unit 300 which is configured to separate different parts of the removed plant parts. Also shown is a storage unit 400 (also referred to as receptacle or seed bunker) which is configured to store removed plant parts, such as storing the removed seed parts. The head 204 of removing unit 200 is connected to the separating unit 300 via first transport means 500 and the separating unit 300 is connected to the storage unit 400 via second transport means 600. These components will also be elucidated further below, particularly in FIGS. 12-15.

FIG. 9 shows a side view of a processing machine 1 according to another embodiment, comprising a processing unit 3 comprising a single picking element (i.e. the flax picking element 129 of FIG. 5), and further a removing unit 200, a separating unit 300 and a storage unit 400.

The embodiment shown in FIG. 9 has the most components and features in common with the embodiment shown in FIG. 8. The difference is that in FIG. 9 the removing unit 200 is mounted on a picking unit 3 which comprises only a single picking element 129. In this case the single picking element comprises the third mounting means 201 for mounting the removing unit. This results in a simpler embodiment in which only the distance between the removing unit and the single picking element can be controllable in the height.

FIG. 10 shows a cross-section of a head 204 of an embodiment of a removing unit 200. This head comprises a housing 210. This housing 210 comprises in this case a rear part 211, a front part 212, two side walls 213 (of which only a single one is shown in FIG. 10) and a maintenance flap 214. The front part 212 of the housing 210 preferably takes an adjustable form for guiding plant parts toward a removing means, for instance the rotatable removing element 220 described below, or conversely away therefrom.

The head 204 of a removing unit 200 will in any case have to be equipped with means for removing seed parts, for instance cutting or ripping off the seed parts, and means for internally catching and collecting the removed plant parts.

The embodiment shown in FIG. 10 comprises for the removal of seed parts a removing rotor 220 comprising several rotor blades 221. These rotor blades 221 are further elucidated below with reference to FIG. 11. The rotatable removing element 220 is preferably arranged in an opening located relatively toward the front and toward the bottom of housing 210 for optimal reachability of the seed parts to be removed. The rotatable removing element 220 will carry the removed seed parts to the interior of the housing. In a favourable device the rotatable removing element 220 will throw the removed seed parts upward to some extent during operation so that they come to lie on or in the displacing means, i.e. the transport unit.

This embodiment further comprises a conveyor belt 230 as means for internally collecting the removed seed parts. This conveyor belt is arranged in the rear part 211 of housing 210. In this case conveyor belt 230 is arranged substantially laterally for the purpose of transporting removed seed parts to one of the sides of head 204, although other orientations are also possible. It is also possible to use a plurality of conveyor belts which preferably carry the removed parts to the same collection point 231 (FIG. 12). It is also possible to provide other transport means, such as a screw conveyor.

This embodiment further comprises a variable drive 240 (not shown specifically). The variable drive 240 is arranged in the housing 210 and can for instance be powered electrically or hydraulically. The variable drive 240 can drive at least one of the rotatable removing element 220 and discharge means for collecting and discharging the removed seed parts (such as a first seed part conveyor 230 and/or a second seed part conveyor). A drive which is variable provides the advantage that the speed and/or force of the driven components can be adjusted in order to process different volumes of plant material or to preventjamming due to blockage.

In this case the maintenance flap 214 is arranged on the upper side of housing 210 and serves to give a service engineer or driver access to the inner side of housing 210 for the purpose of performing maintenance or repairs or to repair malfunctions. Provided here is a cover plate 215 which is arranged in housing 210 such that it is against the wall of housing 210 during operation, in this case against the maintenance flap 214, and such that it moves, in this case rotates, when maintenance flap 214 is opened in order to shield the rotatable removing element 220. This can prevent accidents and/or damage to components.

FIG. 11 shows a detail of an embodiment of a number of teeth 221 (particularly substantially pointed teeth with sharp side edges with substantially round intermediate spaces or recesses 227 between the teeth) of the rotatable removing element 220. The shown detail covers a part of a row of teeth 221 extending radially relative to the central rotor 223 of the rotatable removing element 220. The teeth 221 are mutually connected via a strip 224, which strip is arranged directly on the rotor 223. The shown construction is particularly suitable for guiding and clamping seed parts, particularly the relatively large bolls which are difficult to deform and any material which may be attached thereto, and for removing these seed parts from the fibre plants by rotation of the rotatable removing element 220, particularly by scraping, cutting and/or ripping them off.

FIG. 12 shows a perspective view of an embodiment of the head 204 of a removing unit 200 and of (a part of the) transport means 500. The representation of the different components in FIG. 12 and their relative placement is shown somewhat schematically in order to increase understanding. It can be seen that the rotatable removing element 220 is elongate and runs over substantially the whole width of a picking range of a processing unit 3. Rotatable removing element 220 feeds removed seed parts to a conveyor belt 230 which runs over substantially the same width range and transports the seed parts to a collection point 231, in this case on the side of the head 204 of removing unit 200.

On the side of removing unit 200 where the collection point 231 is situated a second seed part conveyor 500 is provided for transporting seed parts from removing unit 200 to a separating unit 300. This second seed part conveyor 500 comprises a second blower installation 501 and a flexible hose 502 (i.e. blowing hose), wherein the second blower installation 501 is arranged for blowing the seed parts through the flexible hose 502. The blower installation 501 is mounted on the head 204. An extraction installation could otherwise or also be provided at the other outer end of the flexible hose 502 for the purpose of sucking the seed parts through the flexible hose 502. The use of a flexible hose 502 has the advantage that placing of the removing unit 300 relative to the other components of processing machine 1 need not be very precise, so that it need not be set beforehand and the setting could even still be adjusted during use.

FIG. 13 shows a cross-section of embodiments of a separating unit 300, transport means 600 and a storage unit 400. The outer end of flexible hose 502 is also visible here. A separating unit 300 according to the invention is intended to separate different types of seed part, particularly to separate the relatively heavy bolls from light parts such as chaff and/or dust. The separating unit is arranged, preferably releasably, on vehicle chassis 6. For this purpose the separating unit 300 can be configured in different ways. In determined embodiments the separating unit 300 comprises a first cyclone 329 and a second cyclone 310. The separating device 300 can further comprise a breaking unit 320 for breaking the seed parts and/or a dosing element for dosing the discharge. This is the case in the embodiment of FIG. 13.

As shown in FIG. 13, the separating unit 300 can comprise a first receiving space 341 for temporarily holding an accumulating quantity of seed parts. This receiving space 341 can be embodied to collect only the mixture of air and seed parts from the stripper and store it temporarily, but in the shown embodiment the receiving space 341 is embodied as a separating cyclone for a first separation of the incoming mixture.

In embodiments wherein the second seed part conveyor comprises a flexible hose 502, this hose is preferably fastened releasably to head 204 and on the other side to the first receiving space 341. In the shown embodiment wherein the receiving space 341 forms a cyclone the mixture supplied via the second seed part conveyor 500 is introduced via a tangential inlet 33 into the cylindrical housing of cyclone 329 so that the mixture is set into rotation (see arrow 333). The relatively light part of this mixture, so air and light dust particles, moves to the centre of the cyclone and forms a first stream 334 which is carried outside via outlet 339. The relatively heavy part of this mixture, so mainly the seed parts, is discharged as a second stream 336 downward toward the combined breaking and dosing element 320 to be described in more detail below.

The breaking unit 320 is configured to break the seed parts (for instance the bolls) and comprises a drive (not shown, although this can for instance be an electric motor or a hydraulic motor) and a rotatable breaking element 324 (for instance a combination roller), driven by the drive, in a suitable breaking element housing 321 for breaking the bolls into smaller parts. The breaking element 324 can for instance comprise a cylinder with a large number of radial protrusions on the outer surface of the cylinder, so that the protrusions slide along the housing 321 during rotation and the seed parts situated between the protrusions and the inner side of the housing are crushed.

As stated above, a dosing unit can be provided as addition or alternative to the breaking unit 320. A dosing unit makes it possible to discharge a desired quantity of seed parts within a desired period of time in controlled manner. The dosing unit can here be a unit which is separate from the breaking unit. In determined embodiments the breaking unit and dosing unit are however combined, such as the combined breaking/dosing unit designated with reference numeral 320 in the figures. In the embodiment shown in FIG. 13 the rotatable breaking element 324 of the breaking unit 320 is for instance also suitable for dosed discharge of the crushed seed parts by rotating the breaking element, whereby the seed parts flow downward, or conversely stopping it, whereby the flow is interrupted. In other words, the rotatable breaking/dosing element 320 can process the seed parts supplied from space 341 or accumulated therein at a determined, desired speed, which speed does not necessarily correspond to the supply speed from the second seed part conveyor 500.

As alternative or in addition to cyclone 329, separating unit 300 can comprise a screen 330, particularly a vibratable screen, also referred to as vibrating sieve. In the embodiment shown in FIG. 13 the separating unit comprises for instance a vibrating sieve which can be set into vibration with vibrating means (not shown). This sieve has for its object to allow downward passage to small, heavy parts of the seed parts and to agitate larger and/or lighter parts. The vibrating sieve 330 is further arranged at a slight incline in order to carry the parts which were not allowed to pass toward a substantially upright separating space 331. Vibrating sieve 330 is provided with a for instance electric or hydraulic drive 332 whereby the sieve can be shaken and whereby the sieve can also be adjusted in order to set the size of the dosing opening 345 toward the separating space 331. The vibrating sieve 330 can also serve as means for dosing material by distributing this material in the space and/or dosing it over time.

FIG. 13 shows that the broken plant parts (particularly the broken seed parts) find their way from the combined breaking and dosing element 320 downward via a tube 342 and onto the vibrating sieve 330. The vibrating sieve 330 is situated in a screening space 335. The screening space is arranged adjacently of an upright separating space 331. Provided in the wall 343 between the screening space 335 and the upright separating space 331 is a dosing opening 345. The size of this dosing opening 345 is adjustable. The drive 332 of vibrating sieve 330 (which can be utilized to set the sieve into vibration) can also be used to move the vibrating sieve upward in order to make the dosing opening 345 to the upright separating space 331 smaller, or to move it downward in order to make the dosing opening 345 to upright separating space 331 larger, in order to dose the discharge flow. Parts lying on vibrating sieve 330 can be shaken in order to be distributed in the space and in order to move heavy parts downward. Parts which fall through openings in the grating of vibrating sieve 330 come to lie at the bottom of the upright separating space 331.

FIG. 13 further shows that upright separating space 331 is situated between a second cyclone 310 on the upper side of separating unit 300 and a lower outlet 346. Cyclone 310 is provided with a fan which sucks up the stream supplied via dosing opening 345. The sucked-up mixture is discharged to the outside air via a discharge 356 (direction 357). The part of the mixture which was not sucked up, i.e. the relatively heavy parts of the mixture, particularly the seed parts, fall downward under the influence of the force of gravity and are discharged via lower discharge 346 (direction 358), in this case to collecting element 344. In the separating space light parts are carried upward by an air flow generated by cyclone 310, while heavier parts, such as the material of the bolls, move downward and leave the separating space through the lower outlet 346. The material which comes to lie in collecting element 344 can be transported on, for instance to a collecting unit 400, with transport means.

The storage unit 400 of FIG. 13 is embodied to store the relevant seed parts and is arranged, preferably releasably, on vehicle chassis 6. Very different proportions and sizes of storage unit 400 can be opted for in different embodiments.

Further shown in FIG. 13 are transport means 600, which are also arranged, preferably releasably, on vehicle chassis 6, optionally not connected directly to the vehicle chassis but for instance connected fixedly to the storage unit 400. These transport means 600 are configured and arranged to transport bolls and broken material of bolls from separating unit 300 to storage unit 400. In the embodiment of FIG. 13 this takes place from receptacle 344, and transport means 600 comprise a screw conveyor.

FIGS. 14 and 15 show cross-sections of alternative embodiments of a separating unit 700, 800. In the embodiment of FIG. 14 a combined breaking and dosing element 320 and a vibrating sieve 330 are also provided, although in contrast to what is shown in FIG. 13, in this embodiment the removed parts first pass vibrating sieve 330 and then optionally the combined breaking and dosing element 320.

It can be seen that the first receiving space 341 debouches directly onto the vibrating sieve 330, wherein the wall 343 which bounds the dosing opening 345 to the upright separating space 331 is also a wall of receiving space 341.

Air is supplied to the upright separating space 331 through at least one first venting opening 349. In the shown embodiment this first venting opening 349 is provided under vibrating sieve 330, but other placements are also possible. In upright separating space 331 a first separating step takes place, in which relatively large and heavy parts such as bolls leave the separating unit 700 downward toward the lower outlet 346 of the upright separating space 331. A receptacle 344 (not shown in FIG. 14) can be provided here, or the parts leaving separating unit 700 can be carried directly to a storage unit 400 or to the surrounding area. Smaller and/or lighter material in this case leaves separating space 331 via an upper outlet 347 and comes to lie in a second receiving space 348.

Mounted on opposite side of the second receiving space 348 is the cyclone 301 which sucks the material in this case substantially horizontally through the second receiving space 348. Provided in the second receiving space 348 is a deflecting plate 355 which deflects the material downward so that the material passes the combination roller 320, which is in this case provided at the bottom of the second receiving space 348, at a relatively short distance. Relatively heavy parts of the material find their way to combination roller 320, which will break them and discharge them downward. As in the lower outlet 346 of upright separating space 331, a collecting element (not shown in FIG. 14) can be provided, or the material can be carried directly to a storage unit 400 or to the surrounding area. The material can be discharged in the same way and to the same place as the material discharged through the lower outlet 346 of upright separating space 331, or in a different way and/or to a different place. The lighter parts of the material will at least largely pass the combined breaking and dosing element 320, and be carried outside by the airflow of cyclone 301. FIG. 14 further shows that at least a second venting opening 350 is situated in the second receiving space. In the shown embodiment this second venting opening 350 is provided in the upper side of the second receiving space 348, but other placements are also possible.

FIG. 15 shows another embodiment of a separating unit 800. The separating unit here tapers on the upper side toward cyclone 301 while widening on the lower side, wherein the housing has substantially the form of an upright cone. The removed parts are here supplied through a pipe 351 to the centre of the separating unit 800. The supplied parts come to lie in the first receiving space 341 in the radial centre of the housing, which has on the underside a radial dosing opening 345 which is closed adjustably by a closing element 352. The closing element 352 can preferably be driven to control the degree of closure of dosing opening 345 and/or to shake and/or rotate for the same purposes as discussed above in respect of vibrating sieve 330.

Parts passing through the dosing opening 345 come to lie in airflows generated by cyclone 301. Situated under the dosing openings is a lower guide element 353 for preventing parts leaving first receiving space 341 from falling directly down. The lower guide element 353 can be connected to the closing element 352, and can also be driveable thereby. The interior of the housing outside receiving space 341, on the radial outer side of separating unit 800, in this case forms the upright separating space 331. Owing to the lower guide element 353 in upright separating space 331 relatively narrow, substantially upright parts are formed along which the airflows and possibly entrained light parts are discharged upward toward the cyclone 301. Heavier parts such as bolls are guided downward, where they leave separating unit 800 through the lower outlet 361. In the housing, particularly adjacently of and/or under the lower guide element 353, one or more venting openings 360, 350, 359 are provided.

Irrespective of the exact embodiment of the separating unit 800, it is in favourable cases configured to be operatively coupled in use to vehicle 2 such that the driven and/or controllable parts of the separating unit can be controlled from the driver's cab 23, for instance via a fixed or wireless electronic communication connection.

The present invention is not limited to the embodiments described herein. The rights sought are defined by the following claims, within the scope of which numerous modifications can be envisaged. It will thus be apparent to the skilled person that different components of the embodiments of separating unit 300, 700, 800 as shown in FIGS. 13-15 can be assembled in different combinations in order to realize effectively the same operation. It will also be apparent that the use of transport means other than the shown embodiments of the first transport means 500 and second transport means 600 and connecting the removing unit 200, the separating unit 300, 700, 800 and/or the storage unit 400 directly to each other without transport means are possible. It is furthermore possible to dispense with the separating unit and to have the removing unit 200 connect directly to the storage unit 400, or to dispense with storage unit 400 and discharged the bolls elsewhere, for instance to another vehicle which is travelling along.

The present invention is not limited to the embodiments described herein. The rights sought are defined by the following claims, within the scope of which numerous modifications can be envisaged.

1. A processing machine to process fiber plants, the processing machine comprising:
a self-propelling vehicle comprising a vehicle chassis with including a plurality of wheels on the vehicle chassis and a drive motor configured to drive at least one of the wheels, the vehicle chassis being provided with at least one fiber plant conveyor configured to transport at least parts of the fiber plants from a first outer end of the vehicle chassis to an opposite, second outer second end, and with at least one delivering system provided at or close to the second outer end and configured to deliver and place on the ground surface the fiber plants coming from the at least one conveyor;
a seed part remover mounted or mountable on the self-propelling vehicle, the seed part remover being configured to remove seed parts including bolls from the fiber plants to be picked; and
a picker mounted on the self-propelling vehicle, the picker being configured to pick fiber plants from which seed parts have been removed and to transport the picked fiber plants to the at least one fiber plant conveyor of the self-propelling vehicle.

2. The processing machine according to claim 1, further comprising a separator configured to separate the removed seed parts into a first stream and a second stream, the first stream comprising substantially air, chaff particles and dust particles, the second stream comprising substantially seed parts, the separator being one or more of: (i) releasable and (ii) disposed on the vehicle chassis.

3. The processing machine according to claim 1, wherein the seed part remover comprises a stripper configured to remove the seed parts, including the bolls at free outer ends of the fiber plants, from the fiber plants to be picked.

4. The processing machine according to claim 1, wherein the seed part remover comprises a rotatable removing element which is provided with radial fingers configured to remove the seed parts from the fiber plants when the rotatable removing element rotates to strip the seed parts off the fiber plants.

5. The processing machine according to claim 4, wherein the rotatable removing element is configured to one or more of cut off and rip off the seed parts.

6. The processing machine according to claim 4, further comprising a discharge system configured to collect and discharge the removed seed parts.

7. The processing machine according to claim 6, wherein the discharge system comprises one or more of:
(i) a displacement seed part conveyor configured to receive and laterally displace the seed parts removed by the rotatable removing unit of the seed part removing unit, and
(ii) a transport seed part conveyor configured to transport to the vehicle chassis the seed parts transported by the displacement seed part conveyor.

8. The processing machine according to claim 7, wherein the displacement seed part conveyor comprises a lateral conveyor belt extending substantially parallel to the rotatable removing element.

9. The processing machine according to claim 7, wherein the transport seed part conveyor comprises
a flexible tube or hose, and
a fan configured to displace the seed parts supplied by the first displacement part conveyor through the tube or hose.

10. The processing machine according to claim 2, wherein the separator comprises a first discharge first stream and a second discharge the second stream.

11. The processing machine according to claim 10, wherein the separator comprises at least one of:
(i) a separating cyclone configured to separate supplied seed parts into the first stream and second stream by rotation,
(ii) a breaking system configured to break supplied seed parts, and
(iii) a dosing element configured to dose supplied seed parts.

12. The processing machine according to claim 2, wherein the separator comprises a vibratable screen.

13. The processing machine according to claim 1, wherein the self-propelling vehicle further comprises a releasable storage that is a seed part receptacle.

14. The processing machine according claim 1, further comprising a transport system configured to transport one or more of separated seed parts and broken seed parts from a separator to a storage, the transport system comprising a screw conveyor.

15. The processing machine according claim 1, wherein the picker comprises a picking element pivotable in up and downward direction, the picking element comprising at least a pair of driven endless conveyor belts which are configured to grip the fiber plants and transport the fiber plants toward the fiber plant conveyor on the vehicle chassis.

16. The processing machine according claim 15, wherein the picker comprises an additional picking element pivotable in up and downward direction, the additional picking element comprising at least an additional pair of driven endless conveyor belts which are configured to grip fiber plants and transport the fiber plants toward the fiber plant conveyor on the vehicle chassis, a free outer end of the picking element lying at a greater height than a height of a free outer end of the additional picking element to engage the fiber plants at two different heights.

17. The processing machine according claim 16, further comprising a cutter configured to cut the fiber plants to be picked into a lower fiber plant part and an upper fiber plant part, the additional picking element being configured to engage lower fiber plant parts, the picking element being configured to engage upper fiber plant parts.

18. The processing machine according to claim 1, further comprising a top cutter configured to cut respective top parts off the fiber plants.

19. The processing machine according to claim 18, wherein the top cutter is configured to cut the top parts off one or more of:
(i) fiber plants from which the seed parts have already been removed,
(ii) fiber plants which have already been picked, and
iii) fiber plants which were already cut into upper and lower fiber plant parts first and were then picked.

20. The processing machine according to claim 16, further comprising a seed part remover frame configured to support the seed part remover, the seed part remover frame being mounted on one of: the vehicle chassis, the picking element, and the additional picking element.

21. The processing machine according to claim 20, wherein the seed part remover frame is pivotable relative to the vehicle chassis.

22. The processing machine according to claim 16, wherein one or more of the pair of driven endless conveyor belts and the additional pair of driven endless conveyor belts are configured to tilt the engaged fiber plants during transport, tilting the engaged fiber plants from a substantially upright position to a substantially lying position.

23. The processing machine according to claim 1, further comprising at least one actuator configured to adjust the height of the seed part remover relative to the vehicle chassis.

24. The processing machine according to claim 1, further comprising one or more lifters configured to pivot at least one of a first picking element, a second picking element, and a seed part remover frame relative to a ground surface.

25. The processing machine according to claim 1, further comprising a mount system configured to releasably mount one or more of a first picking element, a second picking element, and a seed part remover, on the vehicle chassis.

26. A seed part remover mounted or mountable on a self-propelling vehicle, the seed part remover comprising:
a separator configured to separate seed parts from fiber plants into a first stream and a second stream, the first stream comprising substantially air, chaff particles and dust particles, the second stream comprising substantially seed parts, the separator being one or more of: (i) releasable and (ii) disposed on a vehicle chassis of the self-propelling vehicle.

27. A method of processing fiber plants using the processing machine according to claim 1, the method comprising;
removing the seed parts from the fiber plants; and
subsequently picking the fiber plants.
